(19) United States
(12) Patent Application Publication
(10) Pub. No.: US 2026/0006670 A1
(43) Pub. Date: Jan. 1, 2026

(54) FAILURE RECOVERY IN WIRELESS COMMUNICATION

(71) Applicant: ZTE CORPORATION, Shenzhen (CN)

(72) Inventors: Jiren HAN, Shenzhen (CN); Yin GAO, Shenzhen (CN); Dapeng LI, Shenzhen (CN)

(21) Appl. No.: 18/992,657

(22) PCT Filed: Jul. 22, 2022
(86) PCT No.: PCT/CN2022/107468

§ 371 Date: Jan. 9, 2025

(51) Int. Cl. H04W 76/18; H04W 24/04

(52) U.S. Cl. CPC H04W 76/18; H04W 24/04

(57) ABSTRACT

Methods and systems for techniques for techniques for preventing or reducing failures at a central unit of a base station are disclosed. In an implementation, a method of wireless communication includes receiving, by a first network element, from a user equipment, a signaling connection setup complete message that indicates a connection establishment for a signaling message between the user equipment and a network device associated with the first network element, determining, by the first network element, whether a network slice corresponding to the signaling connection setup complete message is supported by a second network element, and transmitting, by the first network element, the signaling message and information regarding the network slice to a third network element upon determination that the network slice corresponding to the signaling connection setup complete message is not supported by the second network element.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques for preventing or reducing failures at a central unit of a base station.

In one aspect, a method of data communication is disclosed. The method includes receiving, by a first network element, from a user equipment, a signaling connection setup complete message that indicates a connection establishment for a signaling message between the user equipment and a network device associated with the first network element, determining, by the first network element, whether a network slice corresponding to the signaling connection setup complete message is supported by a second network element, and transmitting, by the first network element, the signaling message and information regarding the network slice to a third network element upon determination that the network slice corresponding to the signaling connection setup complete message is not supported by the second network element.

In another aspect, a method of data communication is disclosed. The method includes receiving, by a second network element, from a first network element, a signaling container and a transfer message for transferring a signaling message, wherein the signaling container includes at least one of a signaling connection setup request message that requests a connection for the signaling message or a signaling connection setup complete message that indicates a connection establishment for the signaling message, determining, by the second network element, whether a network slice corresponding to the signaling message is supported by the second network element, and transmitting, by the second network element, the signaling message and information regarding the network slice to a third network element upon determination that the network slice corresponding to the signaling message is not supported by the second network element.

In another aspect, a method of data communication is disclosed. The method includes transmitting, by a first network element, to a second network element, a request message and information regarding a number of user equipment devices being served by a network device associated with the first network element, receiving, by the first network element, from the second network element, a response message, and allocating the user equipment devices among different control planes of the second network element associated with the network device based on the information regarding the number of user equipment devices being served by the network device.

In another example aspect, a wireless communication apparatus comprising a processor configured to implement an above-described method is disclosed

In another example aspect, a computer storage medium having code for implementing an above-described method stored thereon is disclosed.

These, and other, aspects are described in the present document.

### BRIEF DESCRIPTION OF THE DRAWING

FIG. 1 shows an example of a wireless communication system based on some example embodiments of the disclosed technology.

FIG. 2 is a block diagram representation of a portion of an apparatus based on some embodiments of the disclosed technology.

FIG. 3 shows an example architecture for separation of gNB-central unit (CU)-control plane (CP) and gNB-CU-user plane (UP).

FIG. 4 shows an example of F1 application protocol (F1AP) procedure for dedicated central units (CUs) for network slicing based on some embodiments of the disclosed technology.

FIG. 5 shows another example of F1AP procedure for dedicated CUs for network slicing by rerouting procedure based on some embodiments of the disclosed technology.

FIG. 6 shows an example of F1AP procedure for even allocation of users based on some embodiments of the disclosed technology.

FIG. 7 shows another example of F1AP procedure for even allocation of users based on some embodiments of the disclosed technology.

FIG. 8 shows an example of a process for wireless communication based on some example embodiments of the disclosed technology.

FIG. 9 shows another example of a process for wireless communication based on some example embodiments of the disclosed technology.

FIG. 10 shows another example of a process for wireless communication based on some example embodiments of the disclosed technology.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

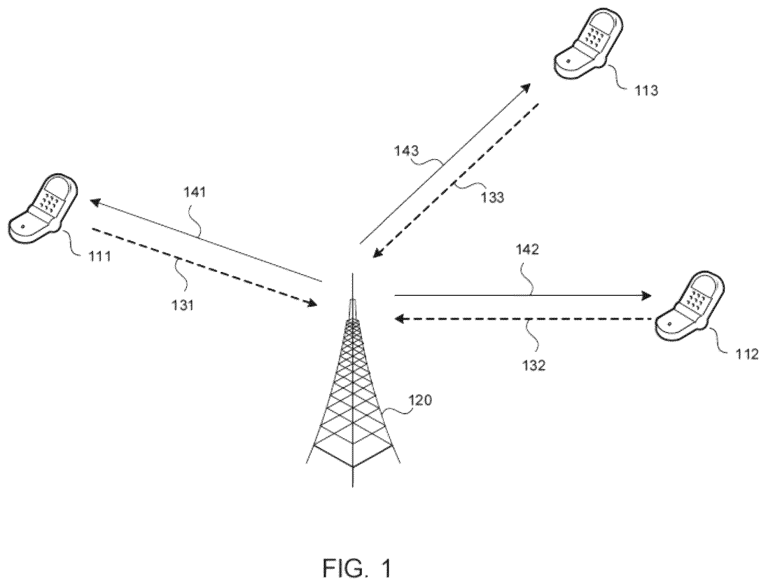

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

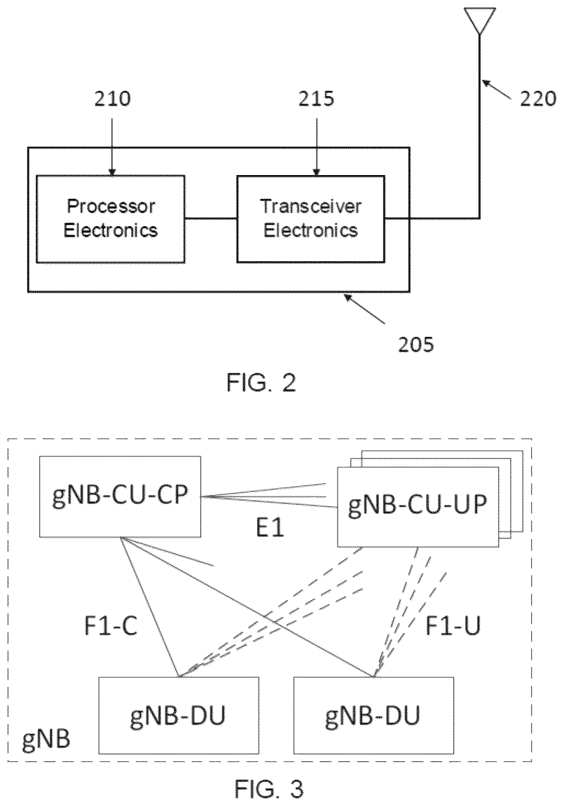

FIG. 2 is a block diagram representation of a portion of an apparatus based on some embodiments of the disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

In a wireless communication network, the next generation radio access network (NG-RAN) architecture may be split by the presence of a single logical gNodeB (gNB)-central unit (CU)-control plane (CP) connected to multiple logical gNB-distributed units (DUs) and logical gNB-CU-user planes (Ups), for each split gNB. In addition, the failures at the gNB-CU (e.g., gNB-CU-CP) may cause interruption of multi-user plane (UP) traffic and disconnection of multiple UEs. The disclosed technology can be implemented in some embodiments to address these issues.

FIG. 3 shows an example architecture for separation of gNB-central unit (CU)-control plane (CP) and gNB-CU-user plane (UP).

In some implementations, a base station (e.g., gNB) may include a control plane of a central unit (e.g., gNB-CU-CP), a plurality of user planes of the control unit (e.g., gNB-CU-UPs) and a plurality of distributed units (e.g., gNB-DUs). In some implementations, the gNB-CU-CP is connected to the gNB-DU through an interface (e.g., F1-C interface). In some implementations, the gNB-CU-UP is connected to the gNB-DU through another interface (e.g., F1-U interface). In some implementations, the gNB-CU-UP is connected to the gNB-CU-CP through the E1 interface. In some implementations, one gNB-DU is connected to only one gNB-CU-CP. In some implementations, one gNB-CU-UP is connected to only one gNB-CU-CP.

In some implementations, a gNB-DU and/or a gNB-CU-UP may be connected to multiple gNB-CU-CPs for resiliency purposes.

In the implementation where a gNB-DU and/or a gNB-CU-UP are/is connected to multiple gNB-CU-CPs, one gNB-DU or gNB-CU-UP is able to connect multiple gNB-CU-UPs at the same time.

In an embodiment of the disclosed technology, the failure of gNB-CU-CP can be prevented or reduced by differentiating central unit (CU) functions across the service. In some implementations, different gNB-CUs may be allocated for different network slices to support different services. In this case, there can be two scenarios. In one scenario where a gNB-CU does not support the selected slice, a gNB-DU can send a radio resource control (RRC) message with slice information to a backup gNB-CU. In another scenario where the gNB-CU detects the failure and it cannot support the selected slice, the gNB-CU can reroute the RRC message with slice information to the backup gNB-CU.

In another embodiment of the disclosed technology, the failure of gNB-CU(-CP) can be prevented or reduced by allocating users (or user equipment devices (UEs)) evenly among the different gNB-CU-CPs. In addition, the number of users in different gNB-CU-CPs may be transmitted from the gNB-DU/gNB-CU-UP to the gNB-CU-CP via F1AP/E1AP messages. In this case, even if one specific gNB-CU-CP detects a failure, the user plane (UP) traffic and the connections of UEs located in other gNB-CU-CPs may not be affected.

Embodiment 1: Dedicated CUs for Network Slicing to support different services.

In some embodiments of the disclosed technology, a gNB-distributed unit (DU) transmits an RRC message with slice information to a backup gNB-central unit (CU) after interpreting the RRC message.

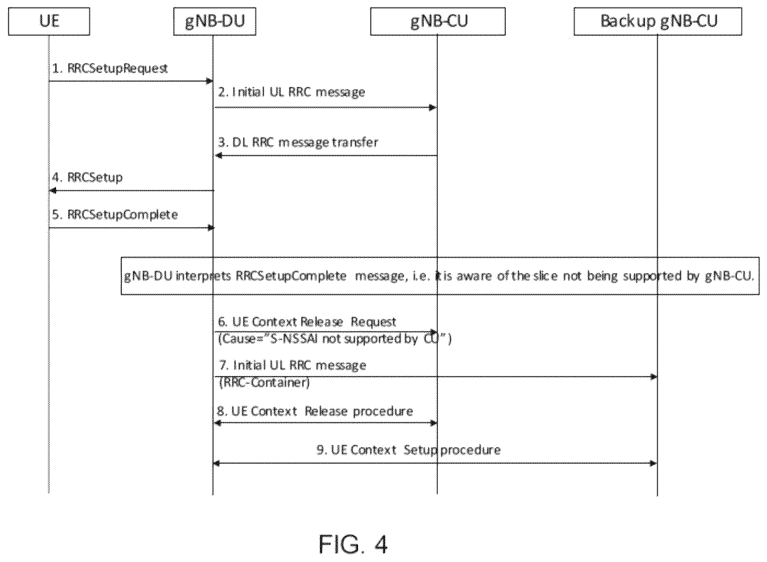

FIG. 4 shows an example of F1 application protocol (F1AP) procedure for dedicated central units (CUs) for network slicing based on some embodiments of the disclosed technology.

At operation 1, a UE transmits an RRC setup request message to a gNB-DU. At operation 2, the gNB-DU transmits an initial uplink (UL) RRC message to a gNB-CU. At operation 3, the gNB-CU transmits a downlink (DL) RRC message transfer message to the gNB-DU. At operation 4, the gNB-DU transmits an RRC setup message to the UE. At operation 5, the UE transmits an RRC setup complete message to the gNB-DU. Operations 1-5 may be a common initial access procedure over F1.

In some implementations of the disclosed technology, after performing the operation 5, the gNB-DU interprets the RRC setup complete message and detects that a slice (e.g., network slice) is not supported by the gNB-CU.

At operation 6, the gNB-DU transmits a UE context release request message to the gNB-CU with a cause value “S-NSSAI (Slice) not supported by the CU.” Here, the cause value can indicate a release cause value.

At operation 7, the gNB-DU transmits an initial UL RRC message with an RRC container to a backup gNB-CU. The RRC container may include at least one of the RRC setup request message or the RRC setup complete message.

At operation 8, the gNB-CU triggers a UE context release procedure to release a UE context.

At operation 9, the backup gNB-CU triggers a UE context setup procedure with the gNB-DU.

In the case of dedicated CUs for network slicing, even if one of gNB-CUs does not support a slice, the gNB-DU is able to re-select a new appropriate gNB-CU to support the same type of service.

Embodiment 2: Dedicated CUs for Network Slicing by rerouting procedure.

In some embodiments of the disclosed technology, a gNB-CU transmits an RRC message with slice information to a backup gNB-CU directly after it detects a failure.

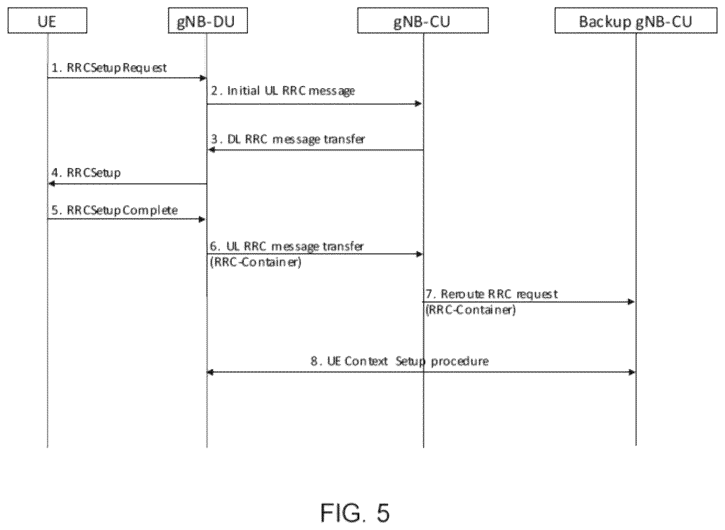

FIG. 5 shows another example of F1AP procedure for dedicated CUs for network slicing by rerouting procedure based on some embodiments of the disclosed technology.

At operation 1, a UE transmits an RRC setup request message to a gNB-DU. At operation 2, the gNB-DU transmits an initial uplink (UL) RRC message to a gNB-CU. At operation 3, the gNB-CU transmits a downlink (DL) RRC message transfer message to the gNB-DU. At operation 4, the gNB-DU transmits an RRC setup message to the UE. At operation 5, the UE transmits an RRC setup complete message to the gNB-DU. Operations 1-5 may be a common initial access procedure over F1.

At operation 6, the gNB-DU transmits an uplink (UL) RRC message transfer message to the gNB-CU with an RRC container. The RRC container may include at least one of the RRC setup request message or the RRC setup complete message, and the slice information is included in the RRC messages.

At operation 7, the gNB-CU detects a failure and yet it cannot support the slice, it can transfer the RRC message with slice information to a backup gNB-CU by performing a reroute RRC request procedure (e.g., XnAP signaling). In some implementations, the reroute RRC request procedure may be a Class 1 procedure or a Class 2 procedure. In addition to the XnAP signaling, the reroute RRC procedure can be handled by using a User Plane method, such as a data forwarding procedure.

At operation 8, the backup gNB-CU triggers a UE context setup procedure with the gNB-DU.

In the case of dedicated CUs for network slicing, even if one of gNB-CUs detects a failure, the gNB-DU is able to reselect a new appropriate gNB-CU to support the same type of services with the old gNB-CU.

Embodiment 3: Even allocation of users among different gNB-CU-CPs.

In some embodiments of the disclosed technology, the gNB-CU-CP transmits the number of users to gNB-DU/gNB-CU-UP.

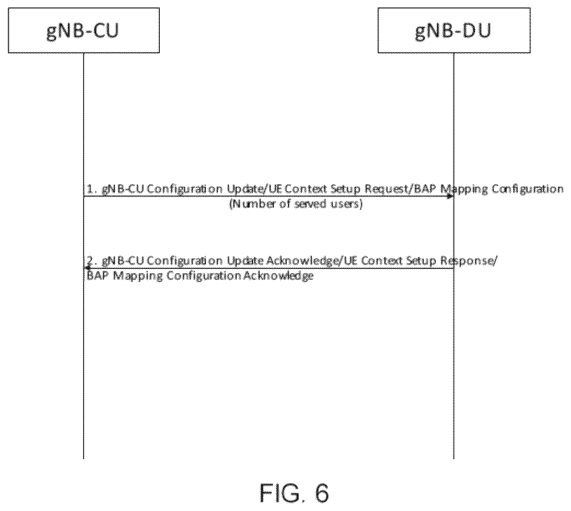

FIG. 6 shows an example of F1AP procedure for even allocation of users based on some embodiments of the disclosed technology.

At operation 1, a gNB-CU transmits an F1 Application Protocol (F1AP) request message to a gNB-DU with the number of its served users. In some implementations, the F1AP request message may be one of: gNB-CU Configuration Update message, or UE Context Setup Request message, or Backhaul Adaptation Protocol (BAP) Mapping Configuration message.

At operation 2, the gNB-DU replies with the corresponding F1AP response message, including one of: gNB-CU Configuration Update Acknowledge message, or UE Context Setup Response message, or BAP Mapping Configuration Acknowledge message.

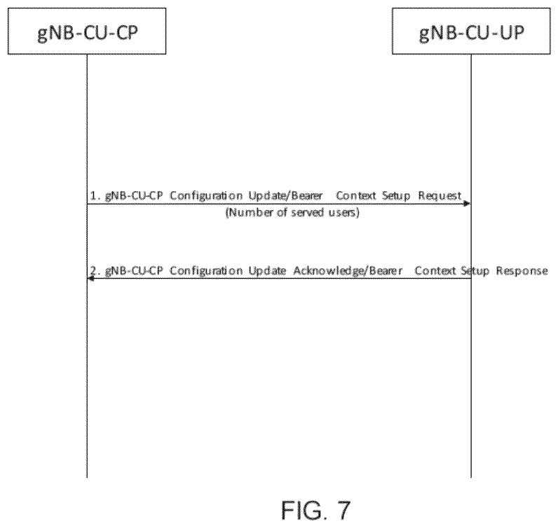

FIG. 7 shows another example of F1AP procedure for even allocation of users based on some embodiments of the disclosed technology.

At operation 1, a gNB-CU-CP transmits an E1AP request message to the gNB-CU-UP with the number of its served users. Furthermore, the E1AP request message could be one of: gNB-CU-CP Configuration Update message, or Bearer Context Setup Request message.

At operation 2, the gNB-CU-UP replies with the corresponding an E1 Application Protocol (E1AP) response message, including one of: gNB-CU-CP Configuration Update Acknowledge message or Bearer Context Setup Response message.

In the case of user allocation, even if one of gNB-CU-CPs detects a failure, not all of the UP traffic and the connection of UEs are affected. For example, in a scenario where there are 100 users being served by gNB-DU in total, and 40 users may be allocated to gNB-CU-CP 1 and 60 users may be allocated to gNB-CU-CP 2, if the gNB-CU-CP detects a failure, the UP traffic and the connection of the remaining 60 users can be maintained.

In the case of dedicated CUs for network slicing, if a gNB-CU does not support a selected slice, a gNB-DU triggers the UE context release request procedure with the cause value “S-NSSAI (Slice) not supported by the CU.” In addition, the gNB-DU transmits an RRC container with slice information to a backup gNB-CU.

In the case of dedicated CUs for network slicing, if a gNB-CU detects the failure and cannot support the slice, the gNB-CU triggers the reroute RRC request procedure to a backup gNB-CU.

In this way, the disclosed technology can be implemented in some embodiments to prevent the failure of the gNB-CU-CP, and allocate the users in the gNB-DU evenly among different gNB-CU-CPs. In this case, even if one of gNB-CU-CPs detects a failure, not all of the UP traffic and the connection of UEs are affected. In addition, the gNB-CU-CP transmits the number of served users to the gNB-DU/gNB-CU-UP via F1AP/E1AP signaling.

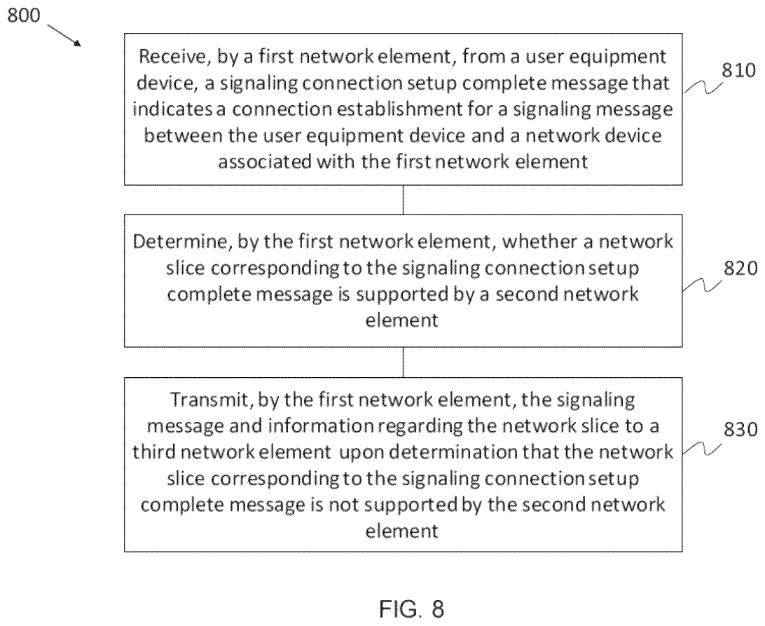

FIG. 8 shows an example of a process for wireless communication based on some example embodiments of the disclosed technology.

In some implementations, the process 800 for wireless communication may include, at 810, receiving, by a first network element, from a user equipment device, a signaling connection setup complete message that indicates a connection establishment for a signaling message between the user equipment device and a network device associated with the first network element, at 820, determining, by the first network element, whether a network slice corresponding to the signaling connection setup complete message is supported by a second network element, and at 830, transmitting, by the first network element, the signaling message and information regarding the network slice to a third network element upon determination that the network slice corresponding to the signaling connection setup complete message is not supported by the second network element.

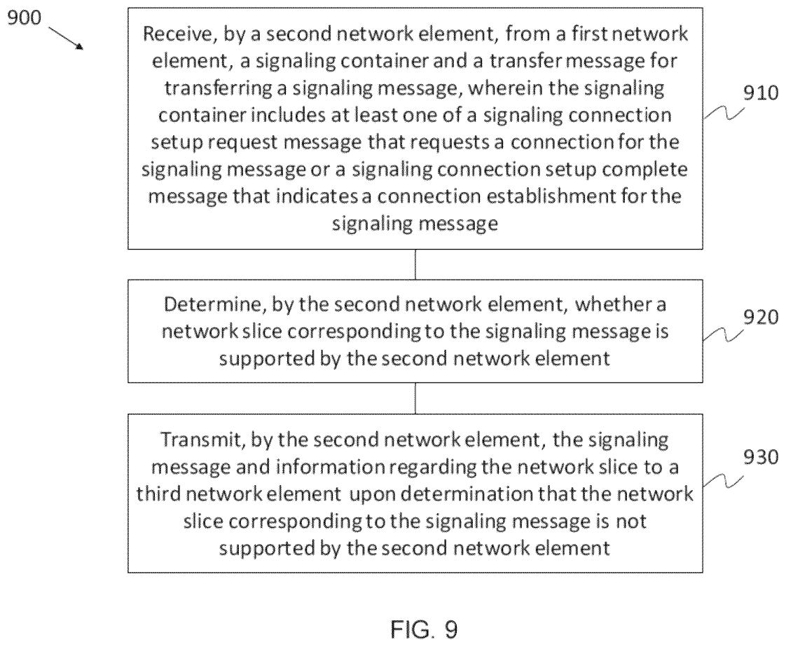

FIG. 9 shows another example of a process for wireless communication based on some example embodiments of the disclosed technology.

In some implementations, the process 900 for wireless communication may include, at 910, receiving, by a second network element, from a first network element, a signaling container and a transfer message for transferring a signaling message, wherein the signaling container includes at least one of a signaling connection setup request message that requests a connection for the signaling message or a signaling connection setup complete message that indicates a connection establishment for the signaling message, at 920, determining, by the second network element, whether a network slice corresponding to the signaling message is supported by the second network element, and at 930, transmitting, by the second network element, the signaling message and information regarding the network slice to a third network element upon determination that the network slice corresponding to the signaling message is not supported by the second network element.

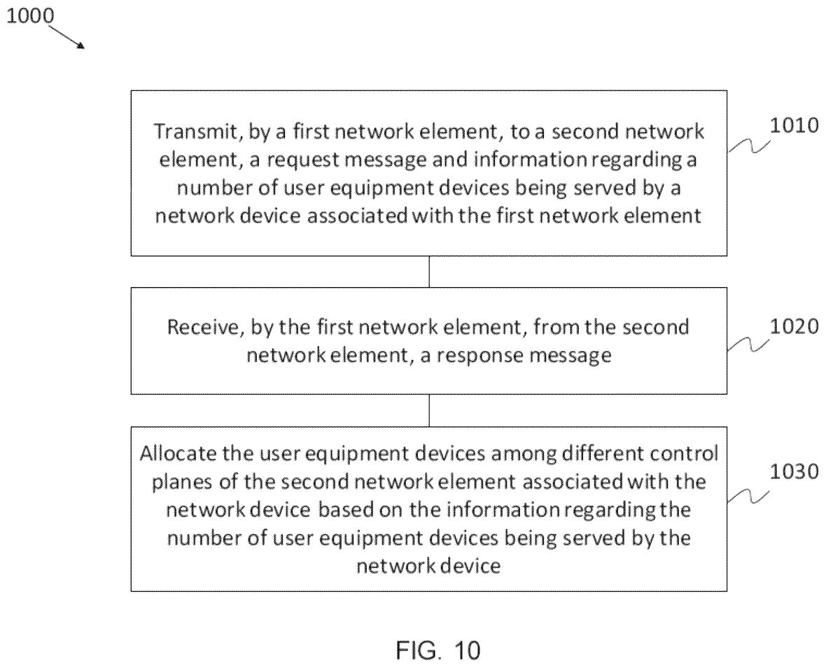

FIG. 10 shows another example of a process for wireless communication based on some example embodiments of the disclosed technology.

In some implementations, the process 1000 for wireless communication may include, at 1010, transmitting, by a first network element, to a second network element, a request message and information regarding a number of user equipment devices being served by a network device associated with the first network element, at 1020, receiving, by the first network element, from the second network element, a response message, and at 1030, allocating the user equipment devices among different control planes of the second network element associated with the network device based on the information regarding the number of user equipment devices being served by the network device.

It will be appreciated that the present document discloses techniques that can be embodied in various embodiments to determine downlink control information in wireless networks. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Some embodiments may preferably implement one or more of the following solutions, listed in clause-format. The following clauses are supported and further described in the embodiments above and throughout this document. As used in the clauses below and in the claims, a wireless device may be user equipment, mobile station, or any other wireless terminal including fixed nodes such as base stations. A network device includes a base station including a next generation Node B (gNB), enhanced Node B (eNB), or any other device that performs as a base station.

Clause 1. A method of wireless communication, comprising: receiving, by a first network element, from a user equipment device, a signaling connection setup complete message that indicates a connection establishment for a signaling message between the user equipment device and a network device associated with the first network element; determining, by the first network element, whether a network slice corresponding to the signaling connection setup complete message is supported by a second network element; and transmitting, by the first network element, the signaling message and information regarding the network slice to a third network element upon determination that the network slice corresponding to the signaling connection setup complete message is not supported by the second network element.

Clause 2. The method of clause 1, further comprising: transmitting, by the first network element, a user equipment context release request message and a release cause value to the second network element, wherein the release cause value indicates that the network slice corresponding to the signaling connection setup complete message is not supported by the second network element.

Clause 3. The method of clause 1, further comprising: transmitting, by the first network element, an initial signaling message and a signaling container to the third network element, wherein the signaling container includes at least one of a connection setup request message or the signaling connection setup complete message.

Clause 4. The method of clause 1, wherein the second network element triggers a user equipment context release procedure to release an established user equipment context.

Clause 5. The method of clause 1, wherein the third network element triggers a user equipment context setup procedure to establish a user equipment context.

Clause 6. A method of wireless communication, comprising: receiving, by a second network element, from a first network element, a signaling container and a transfer message for transferring a signaling message, wherein the signaling container includes at least one of a signaling connection setup request message that requests a connection for the signaling message or a signaling connection setup complete message that indicates a connection establishment for the signaling message; determining, by the second network element, whether a network slice corresponding to the signaling message is supported by the second network element; and transmitting, by the second network element, the signaling message and information regarding the network slice to a third network element upon determination that the network slice corresponding to the signaling message is not supported by the second network element.

Clause 7. The method of clause 6, wherein the transmitting of the signaling message a reroute radio resource control (RRC) request procedure.

Clause 8. The method of clause 6, wherein the third network element triggers a user equipment context setup procedure to establish a user equipment context.

Clause 9. The method of any of clauses 1-8, wherein the first network element includes a distributed unit (DU), the second network element includes a central unit (CU), the third network element includes a backup central unit (CU).

Clause 10. The method of any of clauses 1-8, wherein the signaling includes a radio resource control (RRC) signaling, wherein the connection setup complete message is an RRC setup complete message, the connection setup request message is an RRC setup request message, and the signaling container is an RRC container.

Clause 11. A method of wireless communication, comprising: transmitting, by a first network element, to a second network element, a request message and information regarding a number of user equipment devices being served by a network device associated with the first network element; receiving, by the first network element, from the second network element, a response message; and allocating the user equipment devices among different control planes of the second network element associated with the network device based on the information regarding the number of user equipment devices being served by the network device.

Clause 12. The method of clause 11, wherein the first network element is a central unit (CU) of a base station, and the second network element is a distributed unit (DU) of the base station.

Clause 13. The method of clause 12, wherein the request message includes at least one of next generation node B (gNB)-CU configuration update message, user equipment (UE) context setup request message, or backhaul adaptation protocol (BAP) mapping configuration message.

Clause 14. The method of clause 12, wherein the response message includes gNB-CU configuration update acknowledgement message, UE context setup response message, or BAP mapping configuration acknowledgement message.

Clause 15. The method of clause 11, wherein the first network element is a control plane (CP) of a central unit (CU) of a base station, and the second network element is a user plane (UP) of a central unit (CU) of a base station.

Clause 16. The method of clause 15, wherein the request message includes at least one of gNB-CU-CP configuration update message or bearer context setup request message.

Clause 17. The method of clause 15, wherein the response message includes gNB-CU-CP configuration update acknowledgement message or bearer context setup response message.

Clause 18. An apparatus for wireless communication comprising a processor that is configured to carry out the method of any of clauses 1 to 17.

Clause 19. A non-transitory computer readable medium having code stored thereon, the code when executed by a processor, causing the processor to implement a method recited in any of clauses 1 to 17.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer-or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub- combination. Moreover, although features may be described above as acting in certain combinations and even initially claimed as such, one or more features from a claimed combination can in some implementations be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A method of wireless communication, comprising:
receiving, by a first network element, from a user equipment device, a signaling connection setup complete message that indicates a connection establishment for a signaling message between the user equipment device and a network device associated with the first network element;
determining, by the first network element, whether a network slice corresponding to the signaling connection setup complete message is supported by a second network element; and
transmitting, by the first network element, the signaling message and information regarding the network slice to a third network element upon determination that the network slice corresponding to the signaling connection setup complete message is not supported by the second network element.

2. The method of claim 1, further comprising:
transmitting, by the first network element, a user equipment context release request message and a release cause value to the second network element, wherein the release cause value indicates that the network slice corresponding to the signaling connection setup complete message is not supported by the second network element;
or,
transmitting, by the first network element, an initial signaling message and a signaling container to the third network element, wherein the signaling container includes at least one of a connection setup request message or the signaling connection setup complete message.

3. (canceled)

4. The method of claim 1, wherein the second network element triggers a user equipment context release procedure to release an established user equipment context.

5. The method of claim 1, wherein the third network element triggers a user equipment context setup procedure to establish a user equipment context.

6. A method of wireless communication, comprising:
receiving, by a second network element, from a first network element, a signaling container and a transfer message for transferring a signaling message, wherein the signaling container includes at least one of a signaling connection setup request message that requests a connection for the signaling message or a signaling connection setup complete message that indicates a connection establishment for the signaling message;
determining, by the second network element, whether a network slice corresponding to the signaling message is supported by the second network element; and
transmitting, by the second network element, the signaling message and information regarding the network slice to a third network element upon determination that the network slice corresponding to the signaling message is not supported by the second network element.

7. The method of claim 6, wherein the transmitting of the signaling message is a reroute radio resource control (RRC) request procedure.

8. The method of claim 6, wherein the third network element triggers a user equipment context setup procedure to establish a user equipment context.

9. The method of claim 6, wherein the first network element includes a distributed unit (DU), the second network element includes a central unit (CU), the third network element includes a backup central unit (CU).

10. The method of claim 6, wherein the signaling includes a radio resource control (RRC) signaling, wherein the connection setup complete message is an RRC setup complete message, the connection setup request message is an RRC setup request message, and the signaling container is an RRC container.

11. A method of wireless communication, comprising:
transmitting, by a first network element, to a second network element, a request message and information regarding a number of user equipment devices being served by a network device associated with the first network element;
receiving, by the first network element, from the second network element, a response message; and
allocating the user equipment devices among different control planes of the second network element associated with the network device based on the information regarding the number of user equipment devices being served by the network device.

12. The method of claim 11, wherein the first network element is a central unit (CU) of a base station, and the second network element is a distributed unit (DU) of the base station.

13. The method of claim 12, wherein the request message includes at least one of next generation node B (gNB)-CU configuration update message, user equipment (UE) context setup request message, or backhaul adaptation protocol (BAP) mapping configuration message;
or,
the response message includes gNB-CU configuration update acknowledgement message, UE context setup response message, or BAP mapping configuration acknowledgement message.

14. (canceled)

15. The method of claim 11, wherein the first network element is a control plane (CP) of a central unit (CU) of a base station, and the second network element is a user plane (UP) of a central unit (CU) of a base station.

16. The method of claim 15, wherein the request message includes at least one of gNB-CU-CP configuration update message or bearer context setup request message;
or,
the response message includes gNB-CU-CP configuration update acknowledgement message or bearer context setup response message.

17. (canceled)

18. An apparatus for wireless communication comprising a processor that is configured to carry out the method of claim 1.

19. A non-transitory computer readable medium having code stored thereon, the code when executed by a processor, causing the processor to implement a method recited in claim 1.

20. An apparatus for wireless communication comprising a processor that is configured to carry out the method of claim 6.

21. An apparatus for wireless communication comprising a processor that is configured to carry out the method of claim 11.

22. A non-transitory computer readable medium having code stored thereon, the code when executed by a processor, causing the processor to implement a method recited in claim 6.

23. A non-transitory computer readable medium having code stored thereon, the code when executed by a processor, causing the processor to implement a method recited in claim 11.
